(19) United States
(12) Patent Application Publication
(10) Pub. No.: US 2016/0259193 A1
(43) Pub. Date: Sep. 8, 2016

(54) A TOUCH CONTROL DISPLAY DEVICE

(71) Applicants: CHENGDU BOE OPTOELECTRONICS TECHNOLOGY CO., LTD., Chengdu, Sichuan Province (CN); BOE TECHNOLOGY GROUP CO., LTD., Beijing (CN)

(72) Inventors: Guobo Yang, Beijing (CN); Xiangnan Wang, Beijing (CN)

(73) Assignees: Boe Technology Group Co., Ltd., Beijing (CN); Chengdu Boe Optoelectronics Technology Co., Ltd., Sichuan (CN)

(21) Appl. No.: 14/408,557

(22) PCT Filed: Jun. 6, 2014
(86) PCT No.: PCT/CN2014/000566

§ 371 Date: Dec. 16, 2014

(30) Foreign Application Priority Data
Nov. 13, 2013 (CN) 201310572225.X

(51) Int. Cl. G02F 1/1333; G06F 3/041

(52) U.S. Cl. CPC G02F 1/13338; G06F 3/0412; G06F 2203/04103; G02F 2201/501

(57) ABSTRACT

The present invention provides a touch control display device comprising an array substrate, a counter substrate arranged opposite to the array substrate, and a liquid crystal layer and a touch control layer located between the array substrate and the counter substrate, the counter substrate comprising an alkali glass base substrate. A first shield layer for preventing diffusion of alkali metal ions is formed at a side of the alkali glass base substrate of the counter substrate facing the array substrate, and the liquid crystal layer and the touch control layer are both located between the array substrate and the first shield layer. In the present invention, by forming a first shield layer for preventing diffusion of alkali metal ions at a side of the alkali glass base substrate of the counter substrate facing the array substrate, the alkali metal ions are blocked so that they can not diffuse into other layers of the substrate, so as to ensure physical and chemical stability of the transparent electrode and the liquid crystal in the display device and ensure display effect of the display device.

### FIELD OF THE INVENTION

The present invention relates to the liquid crystal display technology, particularly to a touch control display device.

### BACKGROUND OF THE INVENTION

With the rapid development of the liquid crystal display technology, the investigators have studied the structure of the display screen more deeply. For a touch control liquid crystal display device, a touch control layer (including a touch control electrode) is generally adhered to the exterior of the display side of the display device through an adhesive, and a protection layer is arranged at the outside of the touch control layer. However, such a touch control display device has a relatively great thickness, which goes against the currently popular thin and light display device. Therefore, in an existing scheme, the touch control layer is arranged within the touch control display device, which removes the adhesive and the protection layer and achieves the purpose of being thin and light. In such a scheme, the substrate at the display side will be rubbed or pressed directly when being touched, so it is at least required that the glass base substrate for fabricating the counter substrate (the touched or pressed side, which is also the substrate of the display side generally) arranged opposite to the array substrate has a higher intensity, so as to prevent the glass base substrate from being broken when being touched or pressed. Therefore, the glass base substrate used by the counter substrate (such as a color film substrate) of the touch control display device usually adopts alkali glass containing alkali metal ions. After the alkali glass is treated by toughening, the surface of the alkali glass has a higher intensity than the surface of ordinary glass, thereby being capable of preventing the glass base substrate from being broken when touched or pressed. Moreover, the outer side of the alkali glass also requires no protection layer.

However, since the alkali metal ions may diffuse to the surface of the alkali glass base substrate, it results in degradation of the transparent electrode (such as a pixel electrode, a common electrode and a touch control electrode of the touch control layer) and the liquid crystal layer (for the liquid crystal display device) fabricated on the alkali glass base substrate. Particularly after being used for a long time, the diffusion of the alkali metal ions might result in white opacity generated in the transparent electrode layer, decrease of the transparency, increase of the resistance and to decrease of the physical and chemical stability, thereby influencing the final display effect and shortening the life time of the touch control display device.

### SUMMARY OF THE INVENTION

(I) Technical Problem to be Solved

The technical problem to be solved by the present invention is: how to solve the problem of diffusion of alkali metal ions in the glass base substrate of the touch control display device which may result in decrease of physical and chemical stability of the transparent electrode and the liquid crystal in the display device.

(II) Technical Solution

In order to solve the above technical problem, the present invention provides a touch control display device comprising an array substrate, a counter substrate arranged opposite to the array substrate and a liquid crystal layer and a touch control layer located between the array substrate and the counter substrate, the counter substrate comprising an alkali glass base substrate, characterized in that a first shield layer for preventing diffusion of alkali metal ions is formed at a side of the alkali glass base substrate of the counter substrate facing the array substrate, and the liquid crystal layer and the touch control layer are located between the array substrate and the first shield layer.

According to an embodiment of the present invention, the counter substrate is a color film substrate, the color film substrate comprises a transparent electrode located at a side of the alkali glass base substrate facing the array substrate, and the first shield layer is formed between the transparent electrode and the alkali glass base substrate.

According to an embodiment of the present invention, the touch to control display device further comprises an upper polarizing layer directly formed on an external surface of the alkali glass base substrate.

According to an embodiment of the present invention, the array substrate comprises an alkali glass base substrate, a transparent electrode is layer located at a side of the alkali glass base substrate facing the counter substrate, and a second shield layer for preventing diffusion of alkali metal ions formed between the alkali glass base substrate of the array substrate and the transparent electrode layer of the array substrate.

According to an embodiment of the present invention, the second shield layer may be formed on a surface of the alkali glass base substrate of the array substrate facing the counter substrate.

According to an embodiment of the present invention, the touch control display device further comprises a lower polarizing layer directly formed on an external surface of the alkali glass base substrate of the array substrate.

According to an embodiment of the present invention, the array substrate may further comprise a gate insulating layer, and the second shield layer is the gate insulating layer.

According to an embodiment of the present invention, materials of the first shield layer and the second shield layer are transparent silicon oxide.

According to an embodiment of the present invention, thicknesses of the first shield layer and the second shield layer are 100 nm-360 nm.

According to an embodiment of the present invention, an edge at a side of the alkali glass base substrate of the counter substrate facing away from the array substrate is formed as a curved surface, an inclined surface or a spherical surface.

(III) Beneficial Effect

The present invention provides a touch control display device. By forming a first shield layer for preventing diffusion of alkali metal ions at a side of the alkali glass base substrate of the counter substrate facing the array substrate, the alkali metal ions are blocked so that they can not diffuse into other layers (such as the transparent electrode, the liquid crystal layer etc.) of the substrate, so as to ensure physical and chemical stability of the transparent electrode and the liquid crystal in the display device and ensure display effect of the display device.

### BRIEF DESCRIPTION OF DRAWINGS

FIG. 1 is a structural schematic view of a touch control display device according to an embodiment of the present invention;

FIG. 2 is a structural schematic view of a touch control display device according to another embodiment of the present invention;

FIG. 3 is a structural schematic view of a touch control display device according to a further embodiment of the present invention;

FIG. 4 is a structural schematic view of an alkali glass base substrate of a counter substrate according to an embodiment of the present invention; and

FIG. 5 is a structural schematic view of an alkali glass base substrate of a counter substrate according to another embodiment of the present invention.

### DETAILED DESCRIPTION OF THE INVENTION

In order to explain the technical solutions of the embodiments of the present invention more clearly, the drawings to be used in the description of the embodiments will be introduced briefly next. Apparently, the drawings in the following description are some embodiments of the present invention. The ordinary skilled person in the art can also obtain other drawings based on these drawings. That is to say, the drawings only show exemplary embodiments of the present invention. The present invention can be carried out in various forms and should not be interpreted as only limited to the embodiments described here.

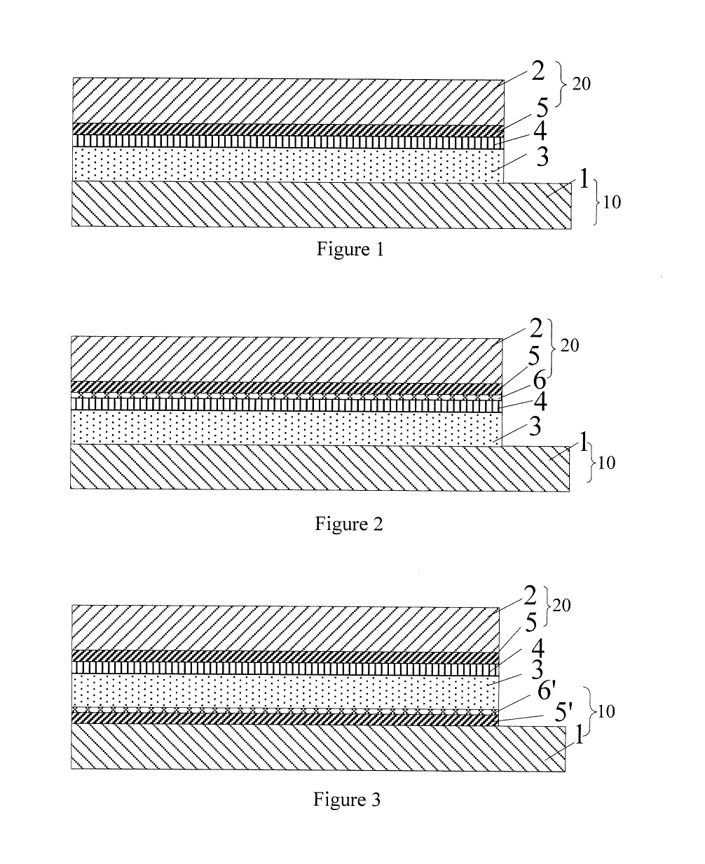

According to an embodiment of the present invention, a touch control display device is provided, as shown in FIG. 1, comprising an array substrate 10, an counter substrate 20 arranged opposite to the array substrate 10, and a liquid crystal layer 3 and a touch control layer 4 (the liquid crystal layer 3 may be located above or under the touch control layer 4, FIG. 1 shows the case in which the liquid crystal layer 3 is located under the touch control layer 4) located between the array substrate 10 and the counter substrate 20. The counter substrate 20 comprises an alkali glass base substrate 2. A first shield layer 5 for preventing diffusion of alkali metal ions is formed at a side of the alkali glass base substrate 2 of the counter substrate 20 facing the array substrate 10, and the liquid crystal layer 3 and the touch control layer 4 are both located at a side of the first shield layer 5 close to the array substrate 10, i.e., located between the array substrate 10 and the first shield layer 5. For the sake of conciseness, FIG. 1 only shows a base substrate 1 of the array substrate 10. The skilled person in the art can understand that the array substrate 10 may further comprise various structures on the base substrate 1, e.g. electrode layer, layers of thin film transistors etc.

In the embodiment of the present invention, by forming a first shield layer 5 for preventing diffusion of alkali metal ions at a side of the alkali glass base substrate 2 of the counter substrate 20 facing the array substrate 10, the alkali metal ions are blocked so that they can not diffuse into the touch control layer 4 and the liquid crystal layer 3, so as to ensure physical and chemical stability of the touch control layer 4 and the liquid crystal.

According to another embodiment of the present invention, the counter substrate 20 may be a color film substrate (for the case in which the color film filter is fabricated on the array substrate, the counter substrate is only a transparent substrate). As shown in FIG. 2, for a liquid to crystal display device in a twisted nematic (TN) mode, the color film substrate may comprise an alkali glass base substrate 2 and a transparent electrode 6 (a common electrode), wherein the transparent electrode 6 is located at a side of the alkali glass base substrate 2 of the color film substrate facing the array substrate 10. The color film substrate further comprises a first shield layer 5 formed between the transparent electrode 6 and the alkali glass base substrate 2. The first shield layer 5 causes the alkali metal ions in the alkali glass base substrate not to diffuse into the transparent electrode 6, so as to ensure physical and chemical stability of the transparent electrode and ensure the display effect of the display device. For the sake of conciseness, FIG. 2 only shows a base substrate 1 of the array substrate 10. The skilled person in the art can understand that the array substrate 10 may further comprise various structures on the base substrate 1, e.g. electrode layer, layers of thin film transistors etc.

Further, according to a further embodiment of the present invention, in order to increase intensity of the whole display device, the base substrates of the counter substrate and the array substrate can be both base substrates with relatively high intensity, e.g. an alkali glass base substrate. In this embodiment, the counter substrate and the array substrate of the touch control display device may comprise a shield layer respectively, so as to prevent the alkali metal ions in the alkali glass base substrates of the two substrates from diffusing into other structures of the substrates. As shown in FIG. 3, the array substrate 10 in the touch control display device comprises an alkali glass base substrate 1, a transparent electrode layer 6′ (a pixel electrode or a common electrode) located at a side of the alkali glass base substrate 1 facing the counter substrate 20, and a second shield layer 5′ for preventing diffusion of alkali metal ions formed between the alkali glass base substrate 1 and the transparent electrode layer 6′. The second shield layer 5′ for example may be formed on the surface of the alkali glass base substrate 1 facing the counter substrate 20, so as to prevent diffusion of the alkali metal ions, as shown in FIG. 3.

According to another embodiment of the present invention, the array substrate 10 may further comprise other layer structures located between the alkali glass base substrate 1 and the transparent electrode layer 6′. The other layer structures for example may comprise layers of thin film is transistors, such as a gate insulating layer, a passivation layer, etc. In such a case, the second shield layer 5′ may be formed between the transparent electrode layer 6′ of the array substrate 10 and the other layer structures.

In addition, for an array substrate in which a thin film transistor is in a top gate structure, the second shield layer 5′ for example may be a gate insulating layer in the array substrate 10. In this way, there is no need to arrange a gate insulating layer additionally, thereby simplifying the process and saving the cost.

According to an embodiment of the present invention, materials of the first shield layer 5 and the second shield layer 5′ may be transparent silicon oxide, and the thicknesses thereof may be 100 nm-360 nm.

According to another embodiment of the present invention, the touch control display device may further comprise an upper polarizing layer and a lower polarizing layer. The upper polarizing layer is directly formed on an external surface (this external surface refers to the surface of the alkali glass base substrate 2 of the counter substrate 20 facing away from the array substrate 10) of the alkali glass base substrate 2 of the counter substrate 20, and the lower polarizing layer is directly formed on an external surface (this external surface refers to the surface of the alkali glass base substrate 1 of the array substrate 10 facing away from the counter substrate 20) of the alkali glass base substrate 1 of the array substrate 10, without using adhesive to adhere with a polarizing layer (an upper polarizing layer and a lower polarizing layer) additionally, thereby reducing the thickness of the whole display device.

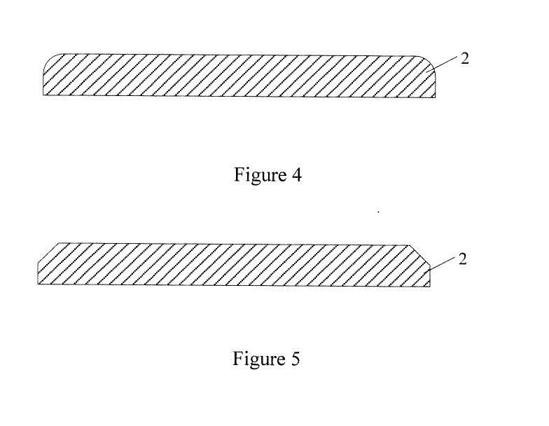

According to another embodiment of the present invention, an edge at a side of the alkali glass base substrate 2 of the counter substrate facing away from the array substrate may be formed as a curved surface, a spherical surface or an inclined surface, or it may be formed as a non-spherical is surface in an arc shape. For example, as shown in FIG. 4, the edge at the side of the alkali glass base substrate 2 of the counter substrate 20 facing away from the array substrate is formed as a curved surface. Alternatively, as shown in FIG. 5, the edge at the side of the alkali glass base substrate 2 of the counter substrate 20 facing away from the array substrate is formed as an inclined surface. The incline angle of this inclined surface may be adjusted based on the size of a frame of the touch control display device.

In a touch control display device where the edge at the side of the alkali glass base substrate of the counter substrate facing away from the array substrate is formed as a curved surface, an inclined surface or a spherical surface, refraction phenomenon occurs when the image passes through the edge of the counter substrate, such that the display path is changed. Therefore, the frame of the display panel seems narrowed, and the frame even cannot be seen, which achieves the visual effect of narrow frame or no frame.

The above embodiments are only used for explaining rather than limiting the present invention. The ordinary skilled person in the art may also make various modifications and variants without deviating from the spirit and scope of the present invention. Therefore, all equivalent technical solutions are also encompassed by the present invention. The protection scope of the present invention should be defined by claims.

1. A touch control display device comprising an array substrate, a counter substrate arranged opposite to the array substrate, and a liquid crystal layer and a touch control layer located between the array substrate and the counter substrate, the counter substrate comprising an alkali glass base substrate,
characterized in that a first shield layer for preventing diffusion of alkali metal ions is formed at a side of the alkali glass base substrate of the counter substrate facing the array substrate, and the liquid crystal layer and the touch control layer are located between the array substrate and the first shield layer.

2. The touch control display device as claimed in claim 1, characterized in that the counter substrate is a color film substrate, the color film substrate comprises a transparent electrode located at a side of the alkali glass base substrate facing the array substrate, and the first shield layer is formed between the transparent electrode and the alkali glass base substrate.

3. The touch control display device as claimed in claim 1, characterized in further comprising an upper polarizing layer directly formed on an external surface of the alkali glass base substrate.

4. The touch control display device as claimed in claim 1, characterized in that the array substrate comprises an alkali glass base substrate, a transparent electrode layer located at a side of the alkali glass base substrate facing the counter substrate, and a second shield layer for preventing diffusion of alkali metal ions formed between the alkali glass base substrate of the array substrate and the transparent electrode layer of the array substrate.

5. The touch control display device as claimed in claim 4, characterized in that the second shield layer is formed on a surface of the alkali glass base substrate of the array substrate facing the counter substrate.

6. The touch control display device as claimed in claim 4, characterized in further comprising a lower polarizing layer directly formed on an external surface of the alkali glass base substrate of the array substrate.

7. The touch control display device as claimed in claim 4, characterized in that the array substrate further comprises a gate insulating layer, and the second shield layer is the gate insulating layer.

8. The touch control display device as claimed in claim 1, characterized in that the material& of the first shield layer is transparent silicon oxide.

9. The touch control display device as claimed in claim 1, characterized in that the thicknesses of the first shield layer is 100 nm-360 nm.

10. The touch control display device as claimed in claim 1, characterized in that an edge at a side of the alkali glass base substrate of the counter substrate facing away from the array substrate is formed as a curved surface, an inclined surface or a spherical surface.

11. The touch control display device as claimed in claim 2, characterized in that the material of the first shield layer is transparent silicon oxide.

12. The touch control display device as claimed claim 2, characterized in that the thickness of the first shield layer is 100 nm-360 nm.

13. The touch control display device as claimed claim 2, characterized in that an edge at a side of the alkali glass base substrate of the counter substrate facing away from the array substrate is formed as a curved surface, an inclined surface or a spherical surface.

14. The touch control display device as claimed in claim 3, characterized in that the material of the first shield layer is transparent silicon oxide.

15. The touch control display device as claimed claim 3, characterized in that the thickness of the first shield layer is 100 nm-360 nm.

16. The touch control display device as claimed claim 3, characterized in that an edge at a side of the alkali glass base substrate of the counter substrate facing away from the array substrate is formed as a curved surface, an inclined surface or a spherical surface.

17. The touch control display device as claimed in claim 4, characterized in that materials of the first shield layer and the second shield layer are transparent silicon oxide.

18. The touch control display device as claimed in claim 4, characterized in that thicknesses of the first shield layer and the second shield layer are 100 nm-360 nm.

19. The touch control display device as claimed claim 4, characterized in that an edge at a side of the alkali glass base substrate of the counter substrate facing away from the array substrate is formed as a curved surface, an inclined surface or a spherical surface.
